(19) United States
(12) Patent Application Publication
(10) Pub. No.: US 2025/0323761 A1
(43) Pub. Date: Oct. 16, 2025

(54) TIMER EXPIRATION IN RESPONSE TO RECEIVING DCI

(71) Applicant: Lenovo (Singapore) Pte. Ltd., New Tech Park (SG)

(72) Inventors: Joachim Löhr, Wiesbaden (DE); Alexander Golitschek Edler von Elbwart, Darmstadt (DE); Prateek Basu Mallick, Dreieich (DE); Ravi Kuchibhotla, Chicago, IL (US)

(21) Appl. No.: 18/690,675

(22) PCT Filed: Sep. 8, 2022
(86) PCT No.: PCT/IB2022/058483

§ 371 Date: Mar. 8, 2024

Related U.S. Application Data
(60) Provisional application No. 63/242,019, filed on Sep. 8, 2021.

(51) Int. Cl. H04L 1/1829; H04L 1/1812; H04W 72/232; H04W 76/28

(52) U.S. Cl. CPC H04L 1/1851; H04L 1/1812; H04W 72/232; H04W 76/28

(57) ABSTRACT

Apparatuses, methods, and systems are disclosed for DRX handling for One-shot HARQ-ACK feedback request message. One method (800) includes receiving (805) receiving DCI during a PDCCH monitoring occasion. Here, the DCI indicates a request for HARQ feedback, and the DCI does not allocate any PDSCH resources. The method (800) includes starting (810) a first timer for a HARQ process in response to receiving the DCI and immediately considering (815) the first timer as expired in response to receiving the DCI.

### CROSS-REFERENCE TO RELATED APPLICATIONS

This application claims priority to U.S. Provisional Patent Application No. 63/242,019 entitled “DRX HANDLING FOR ONE-SHOT HARQ ACK FEEDBACK REQUEST MESSAGE” and filed on 8 Sep. 2021 for Joachim Löhr, Alexander Golitschek Edler von Elbwart, Prateek Basu Mallick, and Ravi Kuchibhotla, which application is incorporated herein by reference.

### FIELD

The subject matter disclosed herein relates generally to wireless communications and more particularly relates to Discontinuous Reception (“DRX”) handling upon reception of certain Downlink Control Information (“DCI”).

### BACKGROUND

DRX allows a communication device to reduce power consumption when there is no uplink (“UL”) or downlink (“DL”) traffic. During DRX operation, the communication device enters a low-power state (e.g., DRX sleep mode) for a predetermined time and periodically enters an active state (e.g., DRX Active Time).

### BRIEF SUMMARY

Disclosed are procedures for DRX handling upon reception of certain DCI. Said procedures may be implemented by apparatus, systems, methods, or computer program products.

One method at a User Equipment (“UE”) includes receiving a DCI during a Physical Downlink Control Channel (“PDCCH”) monitoring occasion. Here, the DCI indicates a request for Hybrid Automatic Repeat Request (“HARQ”) feedback and the DCI does not allocate any Physical Downlink Shared Channel (“PDSCH”) resources. The method includes starting a first timer for a HARQ process in response to receiving the DCI and immediately considering the first timer as expired in response to receiving the DCI.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a block diagram illustrating one embodiment of a wireless communication system for DRX handling for One-shot HARQ Acknowledgement (“HARQ-ACK”) feedback request message;

FIG. 1B depicts a diagram illustrating one embodiment a fixed frame period structure;

FIG. 2 is a block diagram illustrating one embodiment of a 5G New Radio (“NR”) protocol stack;

FIG. 3 is a diagram illustrating one embodiment of an exemplary standards implementation of the first solution;

FIG. 4A is a diagram illustrating one embodiment of an exemplary standards implementation of the second solution;

FIG. 4B is a diagram illustrating one embodiment of an alternate standards implementation of the second solution;

FIG. 5A is a diagram illustrating one embodiment of an exemplary standards implementation of determining a type-3 HARQ-ACK feedback report;

FIG. 5B is a continuation of FIG. 5A;

FIG. 5C is a continuation of FIG. 5B;

FIG. 6 is a block diagram illustrating one embodiment of a user equipment apparatus that may be used for DRX handling for One-shot HARQ-ACK feedback request message;

FIG. 7 is a block diagram illustrating one embodiment of a network apparatus that may be used for DRX handling for One-shot HARQ-ACK feedback request message; and

FIG. 8 is a flowchart diagram illustrating one embodiment of a method for DRX handling for One-shot HARQ-ACK feedback request message.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for mechanisms for DRX handling for One-shot HARQ-ACK feedback request message. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

According to the DRX procedure specified in Third Generation Partnership Project (“3GPP”) Technical Specification (“TS”) 38.321, the drx-HARQ-RTT-TimerDL timer (e.g., corresponding to a configured DL Round Trip Time (“RTT”) for HARQ feedback) is only started for cases when PDCCH schedules a PDSCH reception, i.e., PDCCH indicates a DL transmission.

Correspondingly, if a DRX group is in Active Time, then the UE monitors the PDCCH on the Serving Cells in this DRX group (e.g., as specified in 3GPP TS 38.321). If the PDCCH indicates a DL transmission, then the UE starts the timer drx-HARQ-RTT-TimerDL for the corresponding HARQ process (note that DCI in the PDCCH may indicate a HARQ process) in the first symbol after the end of the corresponding transmission carrying the DL HARQ feedback. Additionally, the UE stops the drx-RetransmissionTimerDL for the corresponding HARQ process. Note that when HARQ feedback is postponed by PDSCH-to-HARQ_feedback timing indication a non-numerical k1 value (e.g., as specified in 3GPP TS 38.213), the correposnding transmission opportunity to send the DL HARQ feedback is indicated in a later PDCCH requesting the HARQ-ACK feedback. Accordingly, if the PDSCH-to-HARQ_feedback timing indicates a non-numerical k1 value—and if the PDCCH indicates a DL transmission, then the UE starts the drx-RetransmissionTimerDL in the first symbol after the PDSCH transmission for the corresponding HARQ process.

However, 3GPP NR specification also support the case where a 5G base station (“gNB”) schedules a PDCCH without scheduling a DL transmission. For example, the gNB may send (via PDCCH) a DCI which indicates the request for a One-shot HARQ-ACK feedback to the UE, i.e., requesting the UE to report a Type-3 HARQ-ACK codebook. Such One-shot HARQ-ACK feedback request message was originally introduced for NR-U in order to provide the gNB means to request the HARQ status information for each of the HARQ processes in case the UE could not report HARQ feedback corresponding to a PDSCH transmission due to Listen-Before-Talk (“LBT”) failures. Additionally, the DCI which indicates the request for a One-shot HARQ-ACK feedback may be sent without an accompanying PDSCH, i.e., DCI format provides a request for a Type-3 HARQ-ACK codebook report and does not schedule a PDSCH.

Specified UE behavior for a One-shot HARQ-ACK feedback request is as follows: if a UE is provided pdsch-HARQ-ACK-OneShotFeedback-r16, and the UE detects a DCI format in any PDCCH monitoring occasion that includes a One-shot HARQ-ACK request field with value 1 and a value of a PDSCH-to-HARQ_feedback timing indicator field, the UE includes the HARQ-ACK information in a Type-3 HARQ-ACK codebook, e.g., as described in 3GPP TS 38.213, clause 9.1.4. A UE determines a PDCCH monitoring occasion on an active DL BWP from the PDCCH monitoring periodicity, the PDCCH monitoring offset, and the PDCCH monitoring pattern within a slot, e.g., as described in 3GPP TS 38.213, clauses 9.1.3, 10 and 13.

If a UE detects a DCI format that includes a One-shot HARQ-ACK request field with value 1, and if the Cyclic Redundancy Check (“CRC”) of the DCI is scrambled by a C-RNTI or an Modulation and Coding Scheme Cell Radio Network Temporary Identifier (“MCS-C-RNTI”), and if resourceAllocation=resourceAllocationType0 and all bits of the frequency domain resource assignment field in the DCI format are equal to 0, or resourceAllocation=resourceAllocationType1 and all bits of the frequency domain resource assignment field in the DCI format are equal to 1, or resourceAllocation=dynamicSwitch and all bits of the frequency domain resource assignment field in the DCI format are equal to 0 or 1, then the DCI format provides a request for a Type-3 HARQ-ACK codebook report and does not schedule a PDSCH reception. The UE is expected to provide HARQ-ACK information in response to the request for the Type-3 HARQ-ACK codebook after N symbols from the last symbol of a PDCCH providing the DCI format, where the value of N for μ=0, 1, 2 is provided in 3GPP TS 38.213, clause 10.2, by replacing “SPS PDSCH release” with “DCI format.”

Because drx-HARQ-RTT-TimerDL is not started for cases that PDCCH does not indicate a DL transmission, it may happen—according to the current behavior specified in 3GPP TS 38.321—that there is no other DRX related timer that keeps the UE listening to PDCCH when the gNB has received a One-shot HARQ-ACK feedback report and intends to send DL assignments, e.g., PDCCH scheduling new initial or retransmissions. In this case, the gNB has to wait until next OnDuration.

On the other hand, as the One-shot feedback, i.e., Type-3 HARQ-ACK codebook report, includes HARQ feedback information for all HARQ processes (and potentially multiple serving cells), starting the drx-HARQ-RTT-TimerDL and stop the drx-RetransmissionTimerDL for all HARQ processes may result in that the UE is not listening for any PDCCH for as long as the drx-HARQ-RTT-TimerDL timer is running (that is, UE may enter DRX sleep mode for a given predefined time which restricts the scheduling opportunities). Such a behavior is detrimental to the user experience (e.g., latency of data delivery) and the network efficiency (e.g., some radio resources cannot be assigned to any UE and are therefore unused).

The solutions described herein disclose embodiments for DRX handling for One-shot HARQ-ACK feedback request message. As used herein, “HARQ-ACK” may represent collectively the Positive Acknowledge (“ACK”) and the Negative Acknowledge (“NACK”). ACK means that a Transport Block (“TB”) is correctly received, while NACK means a TB is erroneously received. In certain embodiments, a HARQ-ACK value may indicate Discontinuous Transmission (“DTX”) when no TB was detected.

According to a first solution, the UE starts (or restarts) the drx-HARQ-RTT-TimerDL for the case of receiving a PDCCH which is not scheduling a PDSCH transmission, e.g., a One-shot HARQ-ACK feedback request (DCI format in any PDCCH monitoring occasion that includes a One-shot HARQ-ACK request field with value 1). Furthermore, the UE immediately considers the drx-HARQ-RTT-TimerDL as expired. Considering the drx-HARQ-RTT-TimerDL as expired would ensure that the drx-RetransmissionTimerDL is started by the UE which in turn starts the Active Time and requires the UE to monitor PDCCH, e.g., gNB is able to schedule new or retransmissions.

As used herein, to “consider” a timer as expired the entity (e.g., UE) regards the timer as having expired—regardless of a value of the timer. When considering a timer as expired, the entity performs those action(s) normally triggered by expiration of the timer. In certain embodiments, the entity will stop and/or reset the timer when considering the timer as expired. In other embodiments, the entity will start another related timer when considering the timer as expired.

According to a second solution, the UE starts (or restarts) the drx-RetransmissionTimerDL in response to receiving a PDCCH which is not indicating a DL transmission, i.e., PDCCH is not allocating PDSCH resources. Such PDCCH not indicating a DL transmission is a One-shot HARQ-ACK feedback request, e.g., DCI format in any PDCCH monitoring occasion that includes a One-shot HARQ-ACK request field with value 1. According to one implementation UE stops the drx-HARQ-RTT-TimerDL timer—if running—before (re)starting the drx-RetransmissionTimerDL timer.

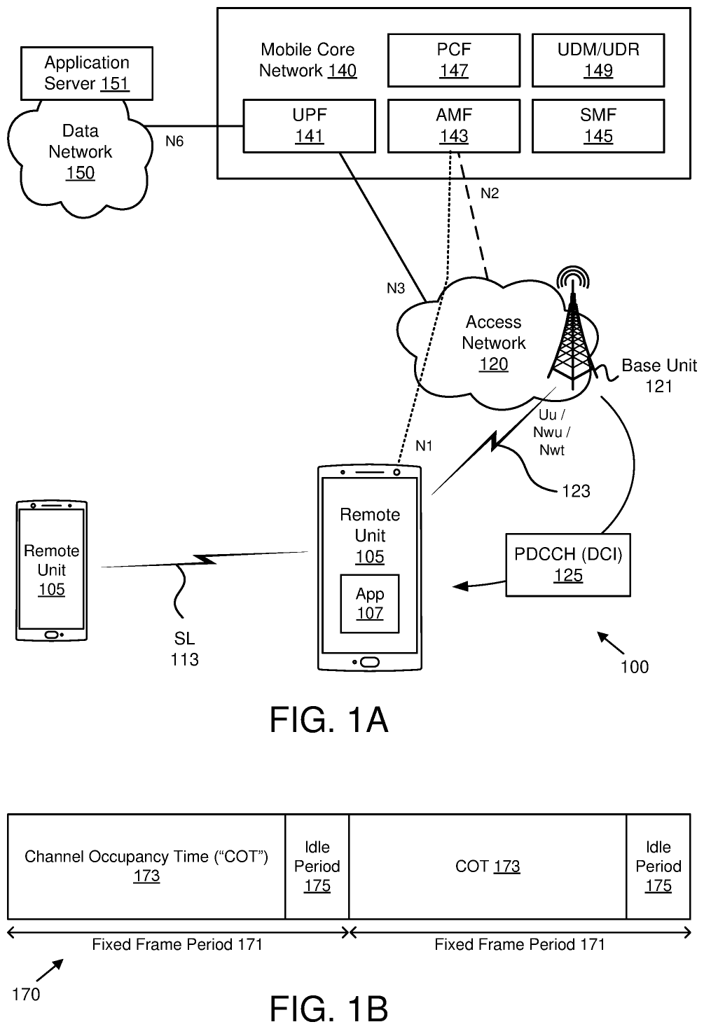

FIG. 1A depicts a wireless communication system 100 for DRX handling for One-shot HARQ-ACK feedback request message, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1A, one of skill in the art will recognize that any number of remote units 105, base units 121, wireless communication links 123, RANs 120, and mobile core networks 140 may be included in the wireless communication system 100.

In one implementation, the RAN 120 is compliant with the 5G cellular system specified in the Third Generation Partnership Project (“3GPP”) specifications. For example, the RAN 120 may be a Next Generation Radio Access Network (“NG-RAN”), implementing NR Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example, the Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via UL and DL communication signals. Furthermore, the UL and DL communication signals may be carried over the wireless communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more DL channels, such as the PDCCH and/or PDSCH. Here, the RAN 120 is an intermediate network that provides the remote units 105 with access to the mobile core network 140.

In various embodiments, the remote units 105 may communicate directly with each other (e.g., device-to-device communication) using sidelink communication 113. Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., Physical Resource Blocks (“PRB”)) over one or more time units (e.g., subframe, slots, Orthogonal Frequency Division Multiplexing (“OFDM”) symbols). In some embodiments, the set of resource blocks comprises contiguous PRBs in the frequency domain. A PRB, as used herein, consists of twelve consecutive subcarriers in the frequency domain.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1A, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1A for ease of illustration, but their support is assumed.

While FIG. 1A depicts components of a 5G RAN and a 5G core network, the described embodiments for DRX handling for One-shot HARQ-ACK feedback request message apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for DRX handling for One-shot HARQ-ACK feedback request message.

In the following, instead of “slot,” the terms “mini-slot,” “subslot,” or “aggregated slots” can also be used, wherein the notion of slot/mini-slot/sub-slot/aggregated slots can be described as defined in 3GPP TS 38.211, 3GPP TS 38.213, and/or 3GPP TS 38.214. Throughout this disclosure reference to 3GPP TS 38.211, 3GPP TS 38.212, 3GPP TS 38.213, 3GPP TS 38.214 is associated with version 16.4.0 of the 3GPP specifications.

It should be mentioned that throughout the disclosure, the terms symbol, slot, subslot and transmission time interval (“TTI”) refers to a time unit with a particular duration (e.g., symbol could be a fraction/percentage of an orthogonal frequency division multiplexing (“OFDM”) symbol length associated with a particular subcarrier spacing (“SCS”)).

In various embodiments, the RAN 120 transmits (e.g., via a base unit 121), during a PDCCH monitoring occasion, a PDCCH transmission 125 comprising DCI that indicates a request for HARQ feedback (e.g., a One-shot HARQ-ACK feedback request), where the DCI does not allocate any PDSCH resources. As described in the below solutions, the receiving remote unit 105 starts (or restarts) a first timer (e.g., the drx-HARQ-RTT-TimerDL) and immediately considers the first timer as expired, in response to receiving the DCI that indicates a request for HARQ feedback and does not allocate any PDSCH resources.

In the following, an UL transmission (e.g., UL transmission burst) may be comprised of multiple transmissions (e.g., of the same or different priority, in case a priority is associated with the transmissions) with gaps between the transmissions, wherein the gaps are short enough in duration to not necessitate performing a channel sensing/LBT operation between the transmissions.

In the following, an UL transmission may refer to a PUSCH transmission, a PUCCH transmission, Random Access Channel (“RACH”) transmission, and/or an UL signal. In certain embodiments, an UL transmission may contain Uplink Control Information (“UCI”), such as Configured Grant UCI (“CG-UCI”) containing information regarding the acquired Channel Occupancy Time (“COT”) such as COT sharing information. In certain embodiments, the UL transmission may contain Scheduling Request (“SR”) or periodic Channel State Information (“CSI”) or semi-persistent CSI. Throughout the disclosure, the terms Channel Occupancy (“CO”) and COT are sometimes used interchangeably. It should be noted that the below described embodiments, examples, and implementations, may also be applicable to sidelink transmissions.

Regarding Operation in Unlicensed Spectrum, devices/network nodes, such as gNBs, that operate in unlicensed/shared spectrum may be required to perform LBT (also referred to as channel sensing) prior to being able to transmit in the unlicensed spectrum. If the device/network node performing LBT does not detect the presence of other signals in the channel, the medium/channel is considered for transmission.

FIG. 1B depicts one embodiment of a Fixed Frame Period structure 170. A Fixed Frame Period (“FFP”) 171 is comprised of a COT 173 and an idle period 175. In Frame-Based Equipment (“FBE”) mode of operation, the UE or gNB performs LBT in a respective idle period 175 and, upon acquiring the channel/medium, the UE or gNB can communicate within the non-idle time of the FFP 171 (referred to as COT 173). In current specifications/regulations, the duration of the idle period 175 is not to be shorter than the maximum of: 5% of the FFP 171, and 100 microseconds (“μs”).

Regarding unlicensed/shared spectrum technology, the following terminologies are defined:

A “channel” refers to a carrier or a part of a carrier consisting of a contiguous set of resource blocks (“RBs”) on which a channel access procedure is performed in shared spectrum.

A “channel access procedure” refers to a sensing-based procedure that evaluates the availability of a channel for performing transmissions. The basic unit for sensing is a sensing slot with a duration Tₛₗ=9 μs. The sensing slot duration Tₛₗ is considered (i.e., treated) to be idle if an eNB/gNB or a UE senses the channel during the sensing slot duration, and determines that the detected power for at least 4 s within the sensing slot duration is less than energy detection threshold X_{Thresh}. Otherwise, the sensing slot duration Tₛₗ is considered (i.e., treated) to be busy.

A “channel occupancy” refers to transmission(s) on channel(s) by eNB(s)/gNB(s) or UE(s) after performing the corresponding channel access procedures, e.g., as described in 3GPP TS 37.213.

A “Channel Occupancy Time” refers to the total time for which the initiating eNB/gNB or UE and any eNB(s)/gNB(s) or UE(s) sharing the channel occupancy perform transmission(s) on a channel, i.e., after an eNB/gNB or UE performs the corresponding channel access procedures, e.g., as described in 3GPP TS 37.213. For determining a Channel Occupancy Time, if a transmission gap is less than or equal to 25 s, the gap duration is counted in the channel occupancy time. A channel occupancy time can be shared for transmission between an eNB/gNB and the corresponding UE(s).

A “DL transmission burst” is defined as a set of transmissions from an eNB/gNB without any gaps greater than 16 s. Transmissions from an eNB/gNB separated by a gap of more than 16 s are considered as separate DL transmission bursts. An eNB/gNB may transmit transmission(s) after a gap within a DL transmission burst without sensing the corresponding channel(s) for availability.

A “UL transmission burst” is defined as a set of transmissions from a UE without any gaps greater than 16 s. Transmissions from the same UE which are separated by a gap of more than 16 s are considered as separate UL transmission bursts. A UE may transmit subsequent transmission(s) after a gap within a UL transmission burst without sensing the corresponding channel(s) for availability.

A UE may perform channel sensing and access the channel if it senses the channel to be idle. UE-initiated COT may be especially useful in low-latency applications, wherein the UE having UL data to be sent in configured grant resources is allowed to initiate a COT. Sometimes, it is useful to share the acquired COT with the gNB, such that gNB could schedule DL or UL for the same UE or for other UEs.

Four Channel Access Priority Classes are defined in 3GPP TS 37.213 which can be used when performing uplink and downlink transmissions in Licensed Assisted Access (“LAA”) carriers.

TABLE 1
Channel Access Priority Class for UL

| Channel | | | | | |
|---|---|---|---|---|---|
| Access | | | | | allowed |
| Priority | | | | | CWₚ |
| Class (p) | mₚ | CW_{min, p} | CW_{max, p} | T_{ulm cot, p} | sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE 1:
For p = 3, 4, T_{ulm cot, p} = 10 ms if the higher layer parameter, ‘absenceOfAnyOtherTechnology-r14’ indicates TRUE, otherwise, T_{ulm cot, p} = 6 ms.
NOTE 2:
When T_{ulm cot, p} = 6 ms it may be increased to 8 ms by inserting one or more gaps. The minimum duration of a gap shall be 100 μs. The maximum duration before including any such gap shall be 6 ms.

For uplink transmissions dynamically scheduled, the eNB selects the Channel Access Priority Class by taking into account the lowest priority QCI in a Logical Channel Group. For UE-initiated uplink transmission on a configured grant resources respectively for Autonomous Uplink (“AUL”) transmissions, UE shall select the lowest channel access priority class (i.e., highest signaled value) of the logical channel with Medium Access Control (“MAC”) Service Data Unit (“SDU”) multiplexed into the MAC PDU. MAC Control Elements (“CEs”)—except padding Buffer Status Report (“BSR”)—apply the highest channel access priority class (i.e., lowest signaled value).

It was proposed to have a separate drx-HARQ-RTT-TimerDL and drx-RetransmissionTimerDL for the One-shot HARQ-ACK feedback. This approach would not interfere with the per-process DRX timers that are associated with specific HARQ processes. This approach also will ensure that the UE is listening to PDCCH after the gNB has received the One-shot HARQ-ACK and may decide to schedule downlink transmission(s) for certain of the HARQ processes, without impact to other HARQ processes that can follow a normal HARQ Round Trip Time (“RTT”) cycle.

However, introducing separate timer values for One-shot HARQ-ACK feedback would require maintenance of two additional timers and require also unnecessary changes in UE behavior. Accordingly, the present disclosure provides solutions for DRX handling for One-shot HARQ-ACK feedback request message without requiring extra signaling and maintenance associated with separate timer values for the One-shot HARQ-ACK feedback request.

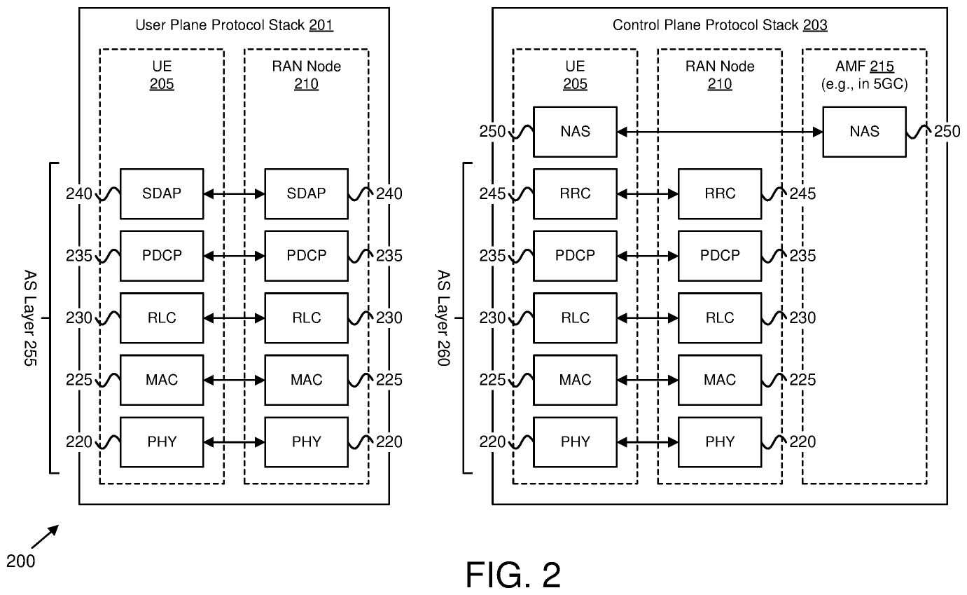

FIG. 2 depicts a NR protocol stack 200, according to embodiments of the disclosure. While FIG. 2 shows the UE 205, the RAN node 210 and an AMF 215 in a 5G core network (“5GC”), these are representative of a set of remote units 105 interacting with a base unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a MAC sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a PHY layer 220, a MAC sublayer 225, a RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer 255 (also referred to as “AS protocol stack”) for the User Plane protocol stack 201 consists of at least SDAP, PDCP, RLC and MAC sublayers, and the physical layer. The AS layer 260 for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC layer 245 and the NAS layer 250 for the control plane and includes, e.g., an IP layer and/or PDU Layer (not depicted) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a beam failure detection procedure using energy detection thresholds, as described herein. In certain embodiments, the PHY layer 220 may send an indication of beam failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and an AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs (also known as TBs) from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the Modulation and Coding Scheme (“MCS”)), the number of physical resource blocks, etc.

Regarding Discontinuous Reception (“DRX”), a MAC entity (e.g., of the MAC sublayer 225) may be configured by an RRC entity (e.g., of the RRC layer 245) with a DRX functionality that controls the UE's PDCCH monitoring activity for the MAC entity's Radio Network Temporary Identifiers (“RNTIs”), such as Cell Radio Network Temporary Identifier (“C-RNTI”), Cancellation Indication Radio Network Temporary Identifier (“CI-RNTI”), Configured Scheduling Radio Network Temporary Identifier (“CS-RNTI”), Interruption/Preemption Radio Network Temporary Identifier (“INT-RNTI”), Slot Format Indicator Radio Network Temporary Identifier (“SFI-RNTI”), Semi-Persistent Channel State Information Radio Network Temporary Identifier (“SP-CSI-RNTI”), Transmit Power Control PUCCH Radio Network Temporary Identifier (“TPC-PUCCH-RNTI”), Transmit Power Control PUSCH Radio Network Temporary Identifier (“TPC-PUSCH-RNTI”), and/or Transmit Power Control Sounding Reference Signal Radio Network Temporary Identifier (“TPC-SRS-RNTI”).

When using DRX operation, the MAC entity also monitors PDCCH, e.g., according to requirements found in 3GPP TS 38.321. When in RRC_CONNECTED, if DRX is configured, for all the activated Serving Cells, the MAC entity may monitor the PDCCH discontinuously using the DRX operation (e.g., as specified in 3GPP TS 38.321, clause 5.7); otherwise, the MAC entity shall monitor the PDCCH as specified in 3GPP TS 38.213.

The RRC entity controls DRX operation by configuring the following parameters: drx-onDurationTimer (i.e., the duration at the beginning of a DRX Cycle); drx-SlotOffset (i.e., the delay before starting the drx-onDurationTimer); drx-InactivityTimer (the duration after the PDCCH occasion in which a PDCCH indicates a new UL or DL transmission for the MAC entity); drx-RetransmissionTimerDL (i.e., the maximum duration until a DL retransmission is received) per DL HARQ process—except for the broadcast process; drx-RetransmissionTimerUL (i.e., the maximum duration until a grant for UL retransmission is received) per UL HARQ process; drx-HARQ-RTT-TimerDL (i.e., the minimum duration before a DL assignment for HARQ retransmission is expected by the MAC entity) per DL HARQ process—except for the broadcast process; drx-HARQ-RTT-TimerUL (i.e., the minimum duration before a UL HARQ retransmission grant is expected by the MAC entity) per UL HARQ process; drx-LongCycleStartOffset (i.e., the start location of the Long DRX cycle); and drx-StartOffset (i.e., which defines the subframe where the Long DRX Cycle starts).

The RRC entity may also configure one or more of the following optional parameters: drx-ShortCycle (the Short DRX cycle—note that drx-StartOffset which defines the subframe where the Short DRX Cycle starts); drx-ShortCycleTimer (the duration the UE shall follow the Short DRX cycle); ps-Wakeup (i.e., the configuration to start associated drx-onDurationTimer in case DCI with CRC scrambled by Power Saving RNTI (“PS-RNTI”) is monitored but not detected); ps-Periodic_CSI_Transmit (i.e., the configuration to report periodic CSI during the time duration indicated by drx-onDurationTimer in case DCI with CRC scrambled by PS-RNTI is configured but associated drx-onDurationTimer is not started); and ps-TransmitPeriodicL1-RSRP (i.e., the configuration to transmit periodic L1-RSRP report(s) during the time duration indicated by drx-onDurationTimer in case DCI with CRC scrambled by PS-RNTI is configured but associated drx-onDurationTimer is not started).

When a DRX cycle is configured, the Active Time includes the time while: A) drx-onDurationTimer or drx-InactivityTimer or drx-RetransmissionTimerDL or drx-RetransmissionTimerUL or ra-ContentionResolutionTimer (e.g., as described in 3GPP TS 38.321, clause 5.1.5) is running; or B) a Scheduling Request is sent on PUCCH and is pending (e.g., as described in 3GPP TS 38.321, clause 5.4.4); or C) a PDCCH indicating a new transmission addressed to the C-RNTI of the MAC entity has not been received after successful reception of a Random Access Response for the Random Access Preamble not selected by the MAC entity among the contention-based Random Access Preamble (e.g., as described in 3GPP TS 38.321, clause 5.1.4).

When DRX is configured, the following MAC entity behaviors apply:

If a MAC PDU is received in a configured downlink assignment, then the MAC entity starts the drx-HARQ-RTT-TimerDL for the corresponding HARQ process in the first symbol after the end of the corresponding transmission carrying the DL HARQ feedback. Additionally, the MAC entity stops the drx-RetransmissionTimerDL for the corresponding HARQ process.

If a MAC PDU is transmitted in a configured uplink grant, then the MAC entity starts the drx-HARQ-RTT-TimerUL for the corresponding HARQ process in the first symbol after the end of the first repetition of the corresponding PUSCH transmission. Additionally, the MAC entity stops the drx-RetransmissionTimerUL for the corresponding HARQ process.

If a drx-HARQ-RTT-TimerDL expires and if the data of the corresponding HARQ process was not successfully decoded, then the MAC entity starts the drx-RetransmissionTimerDL for the corresponding HARQ process in the first symbol after the expiry of drx-HARQ-RTT-TimerDL.

If a drx-HARQ-RTT-TimerUL expires, then the MAC entity starts the drx-RetransmissionTimerUL for the corresponding HARQ process in the first symbol after the expiry of drx-HARQ-RTT-TimerUL.

If a DRX Command MAC Control Element (“CE”) or a Long DRX Command MAC CE is received, then the MAC entity stops drx-onDurationTimer; and also stops drx-InactivityTimer.

If the drx-InactivityTimer expires or a DRX Command MAC CE is received, then if the Short DRX cycle is configured, the MAC entity starts (or restarts) drx-ShortCycleTimer in the first symbol after the expiry of drx-InactivityTimer or in the first symbol after the end of DRX Command MAC CE reception. Also, the MAC entity uses the Short DRX Cycle. Otherwise, if the Short DRX cycle is not configured, then the MAC entity uses the Long DRX cycle.

If the drx-ShortCycle Timer expires, then the MAC entity uses the Long DRX cycle. If a Long DRX Command MAC CE is received, then the MAC entity stops drx-ShortCycleTimer, and uses the Long DRX cycle.

If the Short DRX Cycle is used, and [(SFN×10)+subframe number] modulo (drx-ShortCycle)=(drx-StartOffset) modulo (drx-ShortCycle), then the MAC entity starts the drx-onDurationTimer after drx-SlotOffset from the beginning of the subframe.

If the Long DRX Cycle is used, and [(SFN×10)+subframe number] modulo (drx-LongCycle)=drx-StartOffset, then if DCI with CRC scrambled by PS-RNTI (“DCP”) is configured for the active DL Bandwidth Part (“BWP”), then the MAC entity starts drx-onDurationTimer after drx-SlotOffset from the beginning of the subframe when at least one of the following conditions applies: A) the DCP indication associated with the current DRX Cycle received from lower layer indicates to start drx-onDurationTimer, as specified in 3GPP TS 38.213, or B) all DCP occasion(s) in time domain, as specified in 3GPP TS 38.213, associated with the current DRX Cycle occurred in Active Time considering grants/assignments/DRX Command MAC CE/Long DRX Command MAC CE received and Scheduling Request sent until 4 ms prior to start of the last DCP occasion, or within BWP switching interruption length, or during a measurement gap, or C) ps-Wakeup is configured with value true and DCP indication associated with the current DRX Cycle has not been received from lower layer.

Note that in case of unaligned System Frame Number (“SFN”) across carriers in a cell group, the SFN of the Special Cell (“SpCell,” i.e., a Primary cell or Primary Secondary cell) is used to calculate the DRX duration. If DCP is not configured for the active DL BWP, but the Long DRX Cycle is used, and [(SFN×10)+subframe number] modulo (drx-LongCycle)=drx-StartOffset, then the MAC entity starts the drx-onDurationTimer after drx-SlotOffset from the beginning of the subframe.

While the MAC entity is in Active Time, the MAC entity monitors the PDCCH as specified in 3GPP TS 38.213. If the PDCCH indicates a DL transmission, then the MAC entity starts the drx-HARQ-RTT-TimerDL for the corresponding HARQ process in the first symbol after the end of the corresponding transmission carrying the DL HARQ feedback, regardless of LBT failure indication from lower layers. Note that when HARQ feedback is postponed by PDSCH-to-HARQ_feedback timing indicating a non-numerical k1 value, as specified in 3GPP TS 38.213, the corresponding transmission opportunity to send the DL HARQ feedback is indicated in a later PDCCH requesting the HARQ-ACK feedback.

Additionally, if the PDCCH indicates a DL transmission (while the MAC entity is in Active Time), then the MAC entity stops the drx-RetransmissionTimerDL for the corresponding HARQ process. Further, if the PDSCH-to-HARQ_feedback timing indicates a non-numerical k1 value (e.g. as specified in 3GPP TS 38.213), then the MAC entity starts the drx-RetransmissionTimerDL in the first symbol after the PDSCH transmission for the corresponding HARQ process.

While the MAC entity is in Active Time, if the PDCCH indicates a UL transmission, the MAC entity starts the drx-HARQ-RTT-TimerUL for the corresponding HARQ process in the first symbol after the end of the first repetition of the corresponding PUSCH transmission, regardless of LBT failure indication from lower layers. Additionally, the AMC entity stops the drx-RetransmissionTimerUL for the corresponding HARQ process.

While the MAC entity is in Active Time, if the PDCCH indicates a new transmission (DL or UL), the AMC entity starts (or restarts) the drx-InactivityTimer in the first symbol after the end of the PDCCH reception.

If DCI with CRC scrambled by PS-RNTI (“DCP”) is configured for the active DL BWP; and if the current symbol n occurs within drx-onDurationTimer duration; and if drx-onDurationTimer associated with the current DRX cycle is not started (e.g., as specified in 3GPP TS 38.321, clause 5.7); and if the MAC entity would not be in Active Time considering grants/assignments/DRX Command MAC CE/Long DRX Command MAC CE received and Scheduling Request sent until 4 ms prior to symbol n when evaluating all DRX Active Time conditions (e.g., as specified in 3GPP TS 38.321, clause 5.7), then the MAC entity does not transmit periodic Sounding Reference Signal (“SRS”) and semi-persistent SRS (e.g., as defined in 3GPP TS 38.214) and does not report semi-persistent CSI configured on PUSCH. Additionally, if ps-Periodic_CSI_Transmit is not configured with value true: then if ps-TransmitPeriodicL1-RSRP is not configured with value true, the MAC entity does not report periodic CSI on PUCCH. Otherwise, if ps-TransmitPeriodicL1-RSRP is configured with value true, then the MAC entity does not report periodic CSI on PUCCH, except L1-RSRP report(s).

Otherwise, in current symbol n, if the MAC entity would not be in Active Time considering grants/assignments/DRX Command MAC CE/Long DRX Command MAC CE received and Scheduling Request sent until 4 ms prior to symbol n when evaluating all DRX Active Time conditions (e.g., as specified in 3GPP TS 38.321, clause 5.7), then the MAC entity does not transmit periodic SRS and semi-persistent SRS (e.g., defined in 3GPP TS 38.214) and also does not report CSI on PUCCH and semi-persistent CSI configured on PUSCH. Further, if CSI masking (csi-Mask) is set up by upper layers, then the MAC entity does not report CSI on PUCCH in current symbol n, if drx-onDurationTimer would not be running considering grants/assignments/DRX Command MAC CE/Long DRX Command MAC CE received until 4 ms prior to symbol n when evaluating all DRX Active Time conditions (e.g., as specified in 3GPP TS 38.321, clause 5.7).

Note that if a UE multiplexes a CSI configured on PUCCH with other overlapping UCI(s) according to the procedure specified in 3GPP TS 38.213, clause 9.2.5 and this CSI multiplexed with other UCI(s) would be reported on a PUCCH resource outside DRX Active Time, it is up to UE implementation whether to report this CSI multiplexed with other UCI(s).

Regardless of whether the MAC entity is monitoring PDCCH or not, the MAC entity transmits HARQ feedback, aperiodic CSI on PUSCH, and aperiodic SRS defined in 3GPP TS 38.214 when such is expected. The MAC entity needs not to monitor the PDCCH if it is not a complete PDCCH occasion (e.g., the Active Time starts or ends in the middle of a PDCCH.

According to embodiments of a first solution, the UE (re)starts the drx-HARQ-RTT-TimerDL (for each HARQ process) for the case of receiving a PDCCH which is not scheduling a PDSCH transmission. In one example a DCI in a PDCCH is not indicating a DL transmission if:
a UE detects a DCI format that includes a One-shot HARQ-ACK request field with value 1, and
the CRC of the DCI is scrambled by a C-RNTI or an MCS-C-RNTI, and
resourceAllocation=resourceAllocationType0 and all bits of the frequency domain resource assignment field in the DCI format are equal to 0, or
resourceAllocation=resourceAllocationType1 and all bits of the frequency domain resource assignment field in the DCI format are equal to 1, or
resourceAllocation=dynamicSwitch and all bits of the frequency domain resource assignment field in the DCI format are equal to 0 or 1

Furthermore, according to this first solution, the UE would immediately consider (i.e., treat) the drx-HARQ-RTT-TimerDL as expired. Considering the drx-HARQ-RTT-TimerDL as expired ensures that the drx-RetransmissionTimerDL is started by the UE which in turn starts the Active Time and requires the UE to monitor PDCCH, e.g., the gNB is able to schedule new or retransmissions. It should be noted that since the One-shot HARQ-ACK feedback report, i.e., Type-3 HARQ-ACK codebook report includes HARQ feedback information for all HARQ processes, also the drx-HARQ-RTT-TimerDL is according to this embodiment started and immediately considered as expired for each of the HARQ processes.

According to one specific implementation of this first solution, the UE would apply a different drx-RetransmissionTimerDL value/length for the case that the drx-RetransmissionTimerDL is started in response to the reception of a PDCCH indicating no DL transmission, e.g., One-shot HARQ-ACK feedback request. In one example the length of the drx-RetransmissionTimerDL in response to the reception of a PDCCH indicating no DL transmission would be longer than the configured value of the drx-RetransmissionTimerDL.

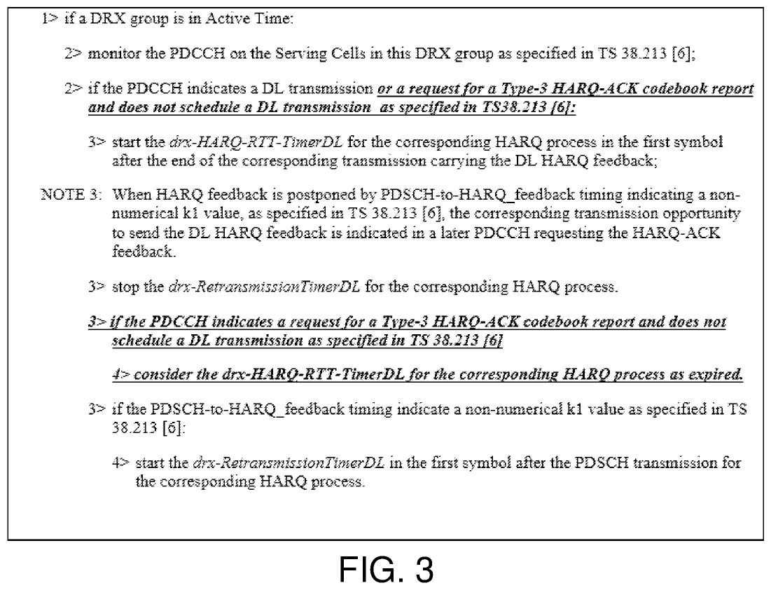

FIG. 3 depicts a first exemplary implementation of the first solution in 3GPP TS 38.321. The newly added part/changes compared to version 16.5.0 of 3GPP TS 38.321 are marked in bold, italic and underline.

According to embodiments of a second solution, the UE starts (or restarts) the drx-RetransmissionTimerDL timer in response to receiving a PDCCH which is not indicating a DL transmission, i.e., PDCCH is not allocating PDSCH resources. In one implementation of the embodiment, a DCI in a PDCCH is not indicating a DL transmission if:
a UE detects a DCI format that includes a One-shot HARQ-ACK request field with value 1, and
the CRC of the DCI is scrambled by a C-RNTI or an MCS-C-RNTI, and
resourceAllocation=resourceAllocationType0 and all bits of the frequency domain resource assignment field in the DCI format are equal to 0, or
resourceAllocation=resourceAllocationType1 and all bits of the frequency domain resource assignment field in the DCI format are equal to 1, or
resourceAllocation=dynamicSwitch and all bits of the frequency domain resource assignment field in the DCI format are equal to 0 or 1

According to one implementation of the second solution, the UE stops the drx-HARQ-RTT-TimerDL timer—if running—before (re)starting the drx-RetransmissionTimerDL timer. It should be noted that since the One-shot HARQ-ACK feedback report, i.e., Type-3 HARQ-ACK codebook report includes HARQ feedback information for all HARQ processes, also the drx-RetransmissionTimerDL is according to this embodiment (re)started for each of the HARQ processes.

According to one specific implementation of the second solution, the UE would apply a different drx-RetransmissionTimerDL value/length for the case that the drx-RetransmissionTimerDL is started in response to the reception of a PDCCH indicating no DL transmission, e.g., One-shot HARQ-ACK feedback request. In one example the length of the drx-RetransmissionTimerDL in response to the reception of a PDCCH indicating no DL transmission would be longer than the configured value of the drx-RetransmissionTimerDL.

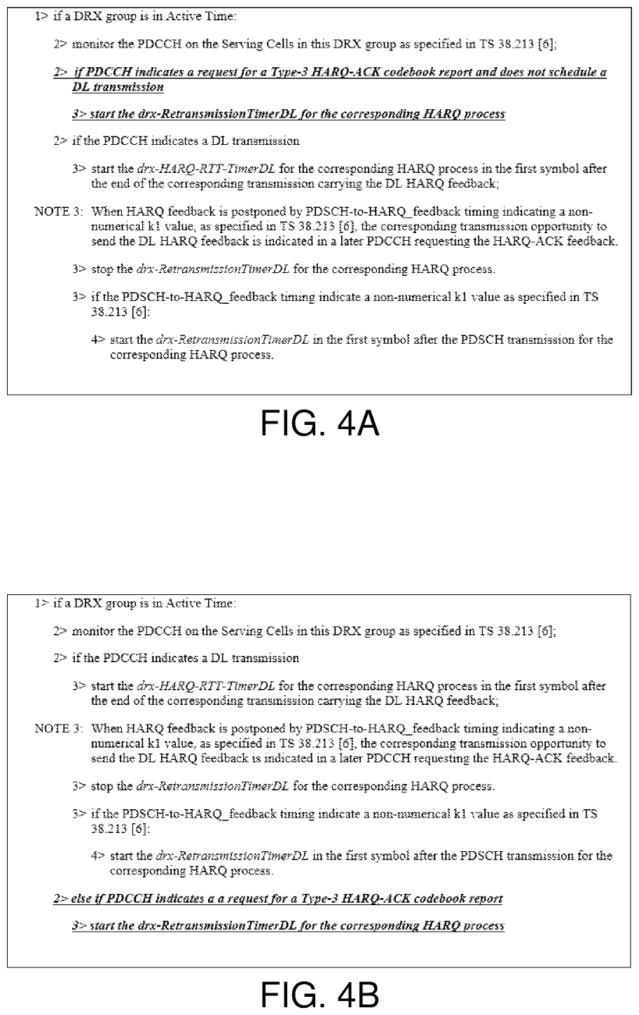

FIG. 4A depicts a first exemplary implementation of the second solution in TS 38.321. The newly added part/changes compared to version 16.5.0 of 3GPP TS 38.321 are marked in bold, italic and underline.

FIG. 4B depicts a second exemplary implementation of the second solution in TS 38.321. The newly added part/changes compared to version 16.5.0 of 3GPP TS 38.321 are marked in bold, italic and underline.

According to embodiments of a third solution, the above first and second solutions may be enhanced when the UE goes directly to Active Time upon reception of a PDCCH requesting a One-shot HARQ feedback report without DL transmission, i.e., drx-RetransmissionTimerDL timer is (re)started for every HARQ process. However, there may be HARQ processes for which the drx-RetransmissionTimerDL or the drx-HARQ-RTT-TimerDL is already running when receiving the One-shot HARQ-ACK feedback request. Basically, the UE may have already provided a HARQ feedback for some of the HARQ processes before receiving the One-shot HARQ-ACK request.

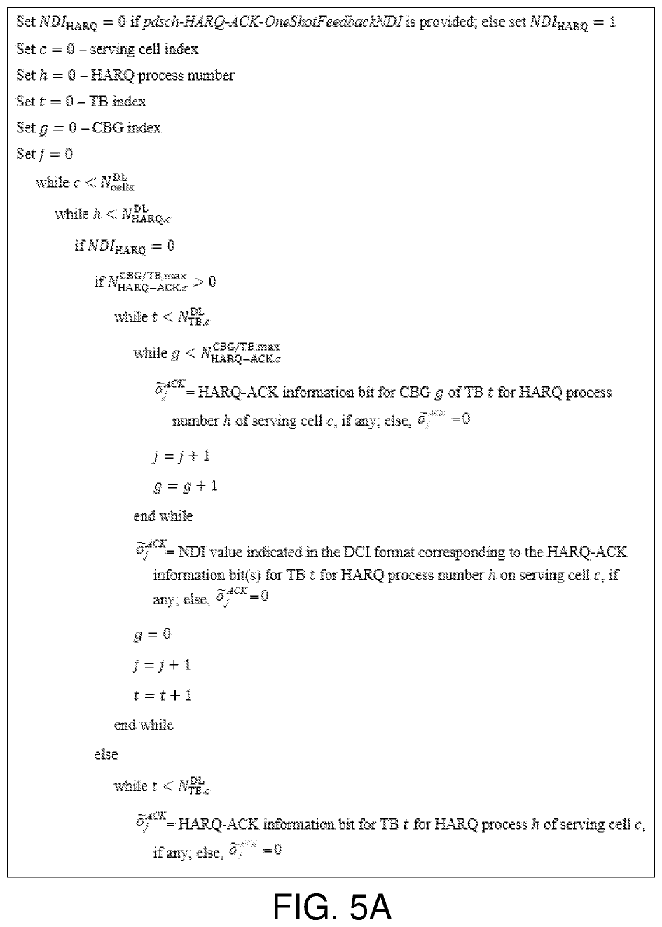

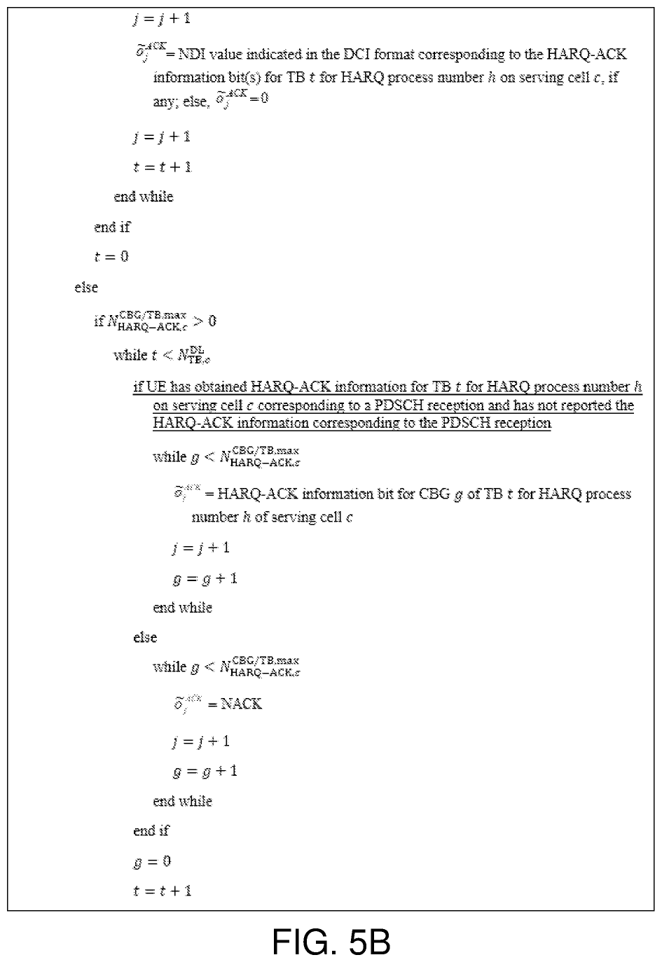

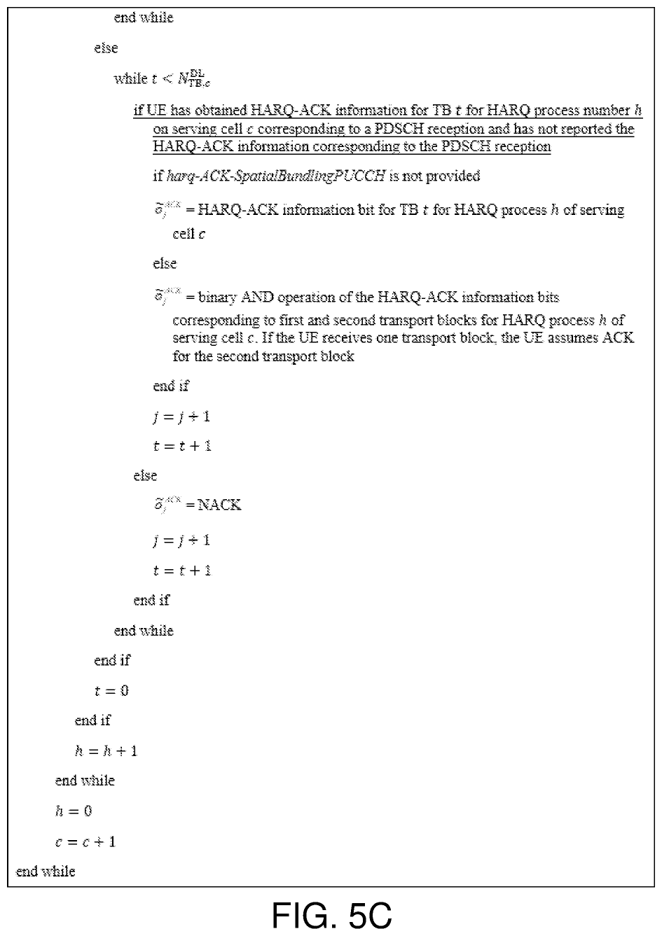

FIGS. 5A-5C depicts modifications to 3GPP TS 38.213 which specify how the UE computes/determines the type-3 HARQ-ACK feedback report. The excerpt from TS 38.213 begins on FIG. 5A and continues on FIG. 5B and FIG. 5C. The newly added parts/changes compared to version 16.5.0 of 3GPP TS 38.321 are marked in underline at FIGS. 5B-5C.

According to a more advanced solution, the UE would only start the drx-HARQ-RTT-TimerDL or the drx-RetransmissionTimerDL for those HARQ processes for which the UE has not obtained the HARQ-ACK information or the UE has not reported the HARQ-ACK information. For those HARQ processes for which the UE has already obtained the HARQ-ACK information and also reported the HARQ-ACK information, e.g., no LBT failure, the UE shall not (re)start the drx-HARQ-RTT-TimerDL timer respectively drx-RetransmissionTimerDL timer.

According to embodiments of a fourth solution, the UE may only (re)start the drx-HARQ-RTT-TimerDL and immediately consider it as expired for those HARQ processes for which either the drx-HARQ-RTT-TimerDL or the drx-RetransmissionTimerDL timer is currently not running. If one of the timers is already running, there is no need to (re)start the drx-HARQ-RTT-TimerDL and consider it as expired.

According to another implementation of the fourth solution, UE (re)starts the drx-HARQ-RTT-TimerDL of a HARQ process upon reception of a One-shot HARQ feedback request not indicating a DL transmission, if the drx-RetransmissionTimerDL timer is currently not running. Even for cases when the drx-HARQ-RTT-TimerDL of a HARQ process is already running, UE (re)starts the drx-HARQ-RTT-TimerDL and considers it immediately expired.

According to one specific implementation of the fourth solution, UE may upon reception of a PDCCH not indicating a DL transmission only (re)start the drx-RetransmissionTimerDL for those HARQ processes for which either the drx-HARQ-RTT-TimerDL or the drx-RetransmissionTimerDL timer is currently not running. According to another implementation of the fourth solution, UE (re)starts the drx-RetransmissionTimerDL of a HARQ process upon reception of a One-shot HARQ feedback request not indicating a DL transmission, if the drx-RetransmissionTimerDL timer is currently not running. Even for cases when the drx-HARQ-RTT-TimerDL of a HARQ process is already running, UE stops the drx-HARQ-RTT-TimerDL and (re)starts the drx-RetransmissionTimerDL.

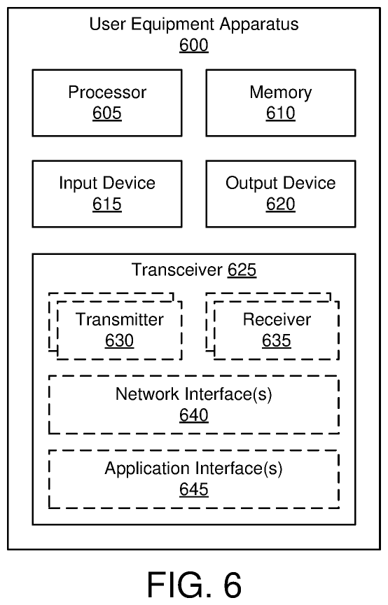

FIG. 6 depicts a user equipment apparatus 600 that may be used for DRX handling for One-shot HARQ-ACK feedback request message, according to embodiments of the disclosure. In various embodiments, the user equipment apparatus 600 is used to implement one or more of the solutions described above. The user equipment apparatus 600 may be one embodiment of a UE endpoint, such as the remote unit 105 and/or the UE 205, as described above. Furthermore, the user equipment apparatus 600 may include a processor 605, a memory 610, an input device 615, an output device 620, and a transceiver 625.

In some embodiments, the input device 615 and the output device 620 are combined into a single device, such as a touchscreen. In certain embodiments, the user equipment apparatus 600 may not include any input device 615 and/or output device 620. In various embodiments, the user equipment apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. In some embodiments, the transceiver 625 communicates with one or more cells (or wireless coverage areas) supported by one or more base units 121. In various embodiments, the transceiver 625 is operable on unlicensed spectrum. Moreover, the transceiver 625 may include multiple UE panels supporting one or more beams. Additionally, the transceiver 625 may support at least one network interface 640 and/or application interface 645. The application interface(s) 645 may support one or more APIs. The network interface(s) 640 may support 3GPP reference points, such as Uu, Nwu, Nwt, N1, PC5, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the user equipment apparatus 600 to implement the above-described UE behaviors. In certain embodiments, the processor 605 may include an application processor (also known as “main processor”) which manages application-domain and operating system (“OS”) functions and a baseband processor (also known as “baseband radio processor”) which manages radio functions.

In various embodiments, via the transceiver 625, the processor 605 receives a DCI transmission on a PDCCH during a PDCCH monitoring occasion. Here, the DCI indicates a request for HARQ feedback and, moreover, the DCI does not allocate any PDSCH resources. The processor 605 starts a first timer for a HARQ process in response to receiving the DCI and immediately considers (i.e., regards) the first timer as expired in response to receiving the DCI.

In some embodiments, to immediately consider the first timer as expired, the processor 605 causes the user equipment apparatus 600 to transition to a DRX active time (e.g., by starting (or restarting) the drx-RetransmissionTimerDL timer). In some embodiments, to immediately consider the first timer as expired, the processor 605 starts a retransmission timer for the HARQ process and, via the transceiver 625, monitors PDCCH transmissions for a DL allocation while the retransmission timer remains active. If a DL allocation is received, the processor 605 processes the allocation by controlling the transceiver 625 to receive a transport block (“TB”) according to the received allocation.

In certain embodiments, the processor 605 maintains a plurality of HARQ processes. In such embodiments, to start the first timer, the processor 605 starts a respective drx-HARQ-RTT-TimerDL timer for each HARQ process for which a respective drx-Retransmission-TimerDL timer is not currently running. In certain embodiments, via the transceiver 625, the processor 605 receives a configured value for the retransmission timer. In such embodiments, to start the first timer, the processor 605 sets a length of the retransmission timer to an extended value that is greater than the configured value.

In some embodiments, to indicate the request for HARQ feedback, the DCI includes a request field indicating a request for a Type-3 HARQ-ACK feedback report. In certain embodiments, the processor 605 maintains a plurality of HARQ processes and, via the transceiver 625, transmits a One-shot HARQ-ACK feedback report. In such embodiments, the One-shot HARQ-ACK feedback report includes HARQ feedback information for each of the plurality of HARQ processes.

In some embodiments, the first timer includes a drx-HARQ-RTT-TimerDL timer. In certain embodiments, the processor 605 maintains a plurality of HARQ processes. In such embodiments, to start the first timer, the processor 605 starts a respective drx-HARQ-RTT-TimerDL timer for each HARQ process for which the respective drx-HARQ-RTT-TimerDL timer is not currently running.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to DRX handling for One-shot HARQ-ACK feedback request message. For example, the memory 610 may store various parameters, panel/beam configurations, resource assignments, policies, and the like as described above. In certain embodiments, the memory 610 also stores program code and related data, such as an operating system or other controller algorithms operating on the user equipment apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 620 may include a wearable display separate from, but communicatively coupled to, the rest of the user equipment apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 communicates with one or more network functions of a mobile communication network via one or more access networks. The transceiver 625 operates under the control of the processor 605 to transmit messages, data, and other signals and also to receive messages, data, and other signals. For example, the processor 605 may selectively activate the transceiver 625 (or portions thereof) at particular times in order to send and receive messages.

The transceiver 625 includes at least transmitter 630 and at least one receiver 635. One or more transmitters 630 may be used to provide UL communication signals to a base unit 121, such as the UL transmissions described herein. Similarly, one or more receivers 635 may be used to receive DL communication signals from the base unit 121, as described herein. Although only one transmitter 630 and one receiver 635 are illustrated, the user equipment apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

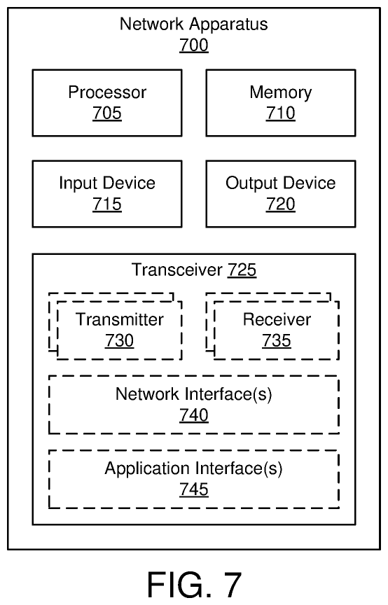

FIG. 7 depicts a network apparatus 700 that may be used for DRX handling for One-shot HARQ-ACK feedback request message, according to embodiments of the disclosure. In one embodiment, network apparatus 700 may be one implementation of a network endpoint, such as the base unit 121 and/or RAN node 210, as described above. Furthermore, the network apparatus 700 may include a processor 705, a memory 710, an input device 715, an output device 720, and a transceiver 725.

In some embodiments, the input device 715 and the output device 720 are combined into a single device, such as a touchscreen. In certain embodiments, the network apparatus 700 may not include any input device 715 and/or output device 720. In various embodiments, the network apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more remote units 105. Additionally, the transceiver 725 may support at least one network interface 740 and/or application interface 745. The application interface(s) 745 may support one or more APIs. The network interface(s) 740 may support 3GPP reference points, such as Uu, N1, N2 and N3. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a CPU, a GPU, an auxiliary processing unit, a FPGA, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the network apparatus 700 is a RAN node (e.g., gNB) that communicates with one or more UEs, as described herein. In such embodiments, the processor 705 controls the network apparatus 700 to perform the above-described RAN behaviors. When operating as a RAN node, the processor 705 may include an application processor (also known as “main processor”) which manages application-domain and operating system (“OS”) functions and a baseband processor (also known as “baseband radio processor”) which manages radio functions.

The memory 710, in one embodiment, is a computer readable storage medium. In some embodiments, the memory 710 includes volatile computer storage media. For example, the memory 710 may include a RAM, including DRAM, SDRAM, and/or SRAM. In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to DRX handling for One-shot HARQ-ACK feedback request message. For example, the memory 710 may store parameters, configurations, resource assignments, policies, and the like, as described above. In certain embodiments, the memory 710 also stores program code and related data, such as an operating system or other controller algorithms operating on the network apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the network apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. One or more transmitters 730 may be used to communicate with the UE, as described herein. Similarly, one or more receivers 735 may be used to communicate with network functions in the PLMN and/or RAN, as described herein. Although only one transmitter 730 and one receiver 735 are illustrated, the network apparatus 700 may have any suitable number of transmitters 730 and receivers 735. Further, the transmitter(s) 730 and the receiver(s) 735 may be any suitable type of transmitters and receivers.

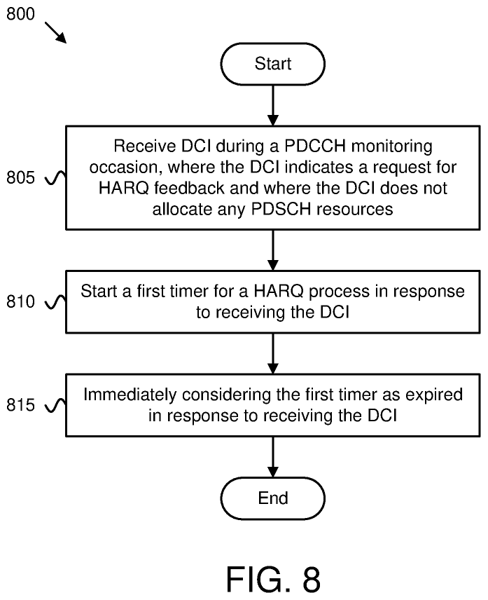

FIG. 8 depicts one embodiment of a method 800 for DRX handling for One-shot HARQ-ACK feedback request message, according to embodiments of the disclosure. In various embodiments, the method 800 is performed by a communication device, such as a remote unit 105, a UE 205, and/or the user equipment apparatus 600, described above. In some embodiments, the method 800 is performed by a processor, such as a microcontroller, a microprocessor, a CPU, a GPU, an auxiliary processing unit, a FPGA, or the like.

The method 800 includes receiving 805 DCI during a PDCCH monitoring occasion, where the DCI indicates a request for HARQ feedback and where the DCI does not allocate any PDSCH resources. The method 800 includes starting 810 a first timer for a HARQ process in response to receiving the DCI. The method 800 and immediately considering 815 the first timer as expired in response to receiving the DCL The method 800 ends.

Disclosed herein is a first apparatus for DRX handling for One-shot HARQ-ACK feedback request message, according to embodiments of the disclosure. The first apparatus may be implemented by a communication device, such as a remote unit 105, a UE 205, and/or the user equipment apparatus 600, described above. The first apparatus includes a processor coupled to a transceiver, the transceiver configured to communicate with a mobile communication network and the processor configured to cause the apparatus to: A) receive DCI during a PDCCH monitoring occasion, where the DCI indicates a request for HARQ feedback and where the DCI does not allocate any PDSCH resources; B) start a first timer for a HARQ process in response to receiving the DCI; and C) immediately consider (i.e., deem) the first timer as expired in response to receiving the DCI.

In some embodiments, to immediately consider the first timer as expired, the processor is configured to cause the apparatus to transition to a DRX active time (e.g., by starting (or restarting) the drx-RetransmissionTimerDL timer). In some embodiments, to immediately consider the first timer as expired, the processor is configured to cause the apparatus to: A) start a retransmission timer for the HARQ process; and B) monitor a PDCCH for a DL allocation while the retransmission timer remains active.

In certain embodiments, the processor is further configured to cause the apparatus to maintain a plurality of HARQ processes. In such embodiments, to start the first timer, the processor is configured to cause the apparatus to start a respective drx-HARQ-RTT-TimerDL timer for each HARQ process for which a respective drx-Retransmission-TimerDL timer is not currently running. In certain embodiments, the processor is further configured to cause the apparatus to receive a configured value for the retransmission timer. In such embodiments, to start the first timer, the processor is configured to cause the apparatus to set a length of the retransmission timer to an extended value that is greater than the configured value.

In some embodiments, to indicate the request for HARQ feedback, the DCI includes a request field indicating a request for a Type-3 HARQ-ACK feedback report. In certain embodiments, the processor is further configured to cause the apparatus to: A) maintain a plurality of HARQ processes, and B) transmit a One-shot HARQ-ACK feedback report, where the One-shot HARQ-ACK feedback report includes HARQ feedback information for each of the plurality of HARQ processes.

In some embodiments, the first timer includes a drx-HARQ-RTT-TimerDL timer. In certain embodiments, the processor is further configured to cause the apparatus to maintain a plurality of HARQ processes. In such embodiments, to start the first timer, the processor is configured to cause the apparatus to start a respective drx-HARQ-RTT-TimerDL timer for each HARQ process for which the respective drx-HARQ-RTT-TimerDL timer is not currently running.

Disclosed herein is a first method for DRX handling for One-shot HARQ-ACK feedback request message, according to embodiments of the disclosure. The first method may be performed by a communication device, such as a remote unit 105, a UE 205, and/or the user equipment apparatus 600, described above. The first method includes receiving DCI during a PDCCH monitoring occasion, where the DCI indicates a request for HARQ feedback and where the DCI does not allocate any PDSCH resources. The first method includes starting a first timer for a HARQ process in response to receiving the DCI and immediately considering (i.e., handling) the first timer as expired in response to receiving the DCI.

In some embodiments, immediately considering the first timer as expired includes transitioning the UE to a DRX active time (e.g., by starting (or restarting) the drx-Retransmission TimerDL timer). In some embodiments, immediately considering the first timer as expired includes starting a retransmission timer for the HARQ process and monitoring a PDCCH for a DL allocation while the retransmission timer remains active.

In certain embodiments, the UE maintains a plurality of HARQ processes, where starting the first timer includes starting a respective drx-HARQ-RTT-TimerDL timer for each HARQ process for which a respective drx-Retransmission-TimerDL timer is not currently running. In certain embodiments, the first method further includes receiving a configured value for the retransmission timer. In such embodiments, starting the retransmission timer includes setting a length of the retransmission timer to an extended value that is greater than the configured value.

In some embodiments, to indicate the request for HARQ feedback, the DCI includes a request field indicating a request for a Type-3 HARQ-ACK feedback report. In certain embodiments, the UE maintains a plurality of HARQ processes, and the first method further includes transmitting a One-shot HARQ-ACK feedback report, where the One-shot HARQ-ACK feedback report includes HARQ feedback information for each of the plurality of HARQ processes.

In some embodiments, the first timer includes a drx-HARQ-RTT-TimerDL timer. In certain embodiments, the UE maintains a plurality of HARQ processes, wherein starting the first timer includes starting a respective drx-HARQ-RTT-TimerDL timer for each HARQ process for which the respective drx-HARQ-RTT-TimerDL timer is not currently running.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
a transceiver; and
a processor coupled to the transceiver, the processor configured to cause the apparatus to:
receive a downlink control information (“DCI”) during a Physical Downlink Control Channel (“PDCCH”) monitoring occasion,
wherein the DCI indicates a request for Hybrid Automatic Repeat Request (“HARQ”) feedback and
wherein the DCI does not allocate any Physical Downlink Shared Channel (“PDSCH”) resources;
start a first timer for a HARQ process in response to receiving the DCI; and
immediately consider the first timer as expired in response to receiving the DCI.

2. The apparatus of claim 1, wherein, to immediately consider the first timer as expired, the processor is configured to cause the apparatus to:
start a retransmission timer for the HARQ process; and
monitor a PDCCH for a downlink allocation while the retransmission timer remains active.

3. The apparatus of claim 2, wherein the processor is further configured to cause the apparatus to maintain a plurality of HARQ processes, and wherein, to start the first timer, the processor is configured to cause the apparatus to start a respective drx-HARQ-RTT-TimerDL timer for each HARQ process for which a respective drx-Retransmission-TimerDL timer is not currently running.

4. The apparatus of claim 2, wherein the processor is further configured to cause the apparatus to receive a configured value for the retransmission timer, and wherein, to start the first timer, the processor is configured to cause the apparatus to set a length of the retransmission timer to an extended value that is greater than the configured value.

5. The apparatus of claim 1, wherein, to immediately consider the first timer as expired, the processor is configured to cause the apparatus to transition to a discontinuous reception (“DRX”) active time.

6. The apparatus of claim 1, wherein, to indicate the request for HARQ feedback, the DCI comprises a request field indicating a request for a Type-3 HARQ acknowledgment (“HARQ-ACK”) feedback report.

7. The apparatus of claim 6, wherein the processor is further configured to cause the apparatus to:
maintain a plurality of HARQ processes, and
transmit a One-shot HARQ-ACK feedback report comprising HARQ feedback information for each of the plurality of HARQ processes.

8. The apparatus of claim 1, wherein the first timer comprises a drx-HARQ-RTT-TimerDL timer.

9. The apparatus of claim 8, wherein the processor is further configured to cause the apparatus to maintain a plurality of HARQ processes, and wherein to start the first timer, the processor is configured to cause the apparatus to start a respective drx-HARQ-RTT-TimerDL timer for each HARQ process for which the respective drx-HARQ-RTT-TimerDL timer is not currently running.

10. A method of a User Equipment (“UE”), the method comprising:
receiving a downlink control information (“DCI”) during a Physical Downlink Control Channel (“PDCCH”) monitoring occasion,
wherein the DCI indicates a request for Hybrid Automatic Repeat Request (“HARQ”) feedback and
wherein the DCI does not allocate any Physical Downlink Shared Channel (“PDSCH”) resources;
starting a first timer for a HARQ process in response to receiving the DCI; and
immediately considering the first timer as expired in response to receiving the DCI.

11. The method of claim 10, wherein immediately considering the first timer as expired comprises:
starting a retransmission timer for the HARQ process; and
monitoring a PDCCH for a downlink allocation while the retransmission timer remains active.

12. The method of claim 11, wherein the UE maintains a plurality of HARQ processes, wherein starting the first timer comprises starting a respective drx-HARQ-RTT-TimerDL timer for each HARQ process for which a respective drx-Retransmission-TimerDL timer is not currently running or for which the respective drx-HARQ-RTT-TimerDL timer is not currently running.

13. The method of claim 10, wherein immediately considering the first timer as expired comprises transitioning the UE to a discontinuous reception (“DRX”) active time.

14. The method of claim 10, wherein, to indicate the request for HARQ feedback, the DCI comprises a One-shot HARQ-ACK request field indicating the request for a type-3 HARQ-ACK feedback report.

15. The method of claim 10, wherein the first timer comprises a drx-HARQ-RTT-TimerDL timer.
